(19) United States
(12) Patent Application Publication
(10) Pub. No.: US 2022/0004819 A1
(43) Pub. Date: Jan. 6, 2022

(54) ELECTRONIC DEVICE AND CONTROLLING METHOD OF ELECTRONIC DEVICE

(71) Applicant: SAMSUNG ELECTRONICS CO., LTD., Suwon-si (KR)

(72) Inventors: Rajat MODI, Noida (IN); Sreekar BATHULA, Noida (IN); Vishnu Teja NELLURU, Noida (IN); Manish SHARMA, Noida (IN)

(73) Assignee: SAMSUNG ELECTRONICS CO., LTD., Suwon-si (KR)

(21) Appl. No.: 17/366,487

(22) Filed: Jul. 2, 2021

(30) Foreign Application Priority Data
Jul. 3, 2020 (IN) 202011028409
Oct. 20, 2020 (KR) 10-2020-0136320

(51) Int. Cl. G06K 9/62; G06T 7/70; G06N 3/04; G06N 3/08

(52) U.S. Cl. CPC G06K 9/6263; G06T 7/70; G06K 9/6221; G06K 9/6256; G06Q 30/0201; G06N 3/0454; G06N 3/088; G06T 2207/20081; G06T 2207/20084; G06K 9/6215

(57) ABSTRACT

The present subject matter is related to a content-generation method in a computing-environment based on artificial neural network (ANN) such as generative adversarial network (GAN). An external-input for generation of content may be received by a Generative adversarial network (GAN); the GAN may be configured to operate in respect of a plurality of target domain attributes (TDA) for a target domain. A plurality of target domain attribute (TDA) may shortlisted from the plurality of TDA based at least one of the external input and one or more clusters associated with the plurality of TDA. Data may be interpolated within a latent space defined by representations of the shortlisted TDA.

### CROSS REFERENCE TO RELATED APPLICATIONS

This application claims benefit of priority to India Patent Application No. 202011028409 filed Jul. 3, 2020 in the Indian Patent Office and Korean Patent Application No. 10-2020-0136320 filed Oct. 20, 2020 in the Korean Patent Office. The content of the above are incorporated by reference herein.

### BACKGROUND

### 1. Field

The present disclosure relates to an electronic device and a method of controlling thereof, and more particularly, to an electronic device configured to render a change in content generated based on an interaction with a user, and a method for controlling thereof.

### 2. Description of Related Art

Aggregators canvassing and selling goods through e-portals are commonplace and have done away with the need of brick and mortar stores. Accordingly, a patron may browse and select items of his choice from the comfort of home. However, despite all the bandwidth and resources, e-commerce websites like brick and mortar stores end up illustrating a limited number of items as a part of their inventory. Accordingly, patrons may be dismayed or dissatisfied with available electronic inventory.

Even if there are a huge variety of on-screen displayed products or content-items, the quantity however fails to map with the qualitative-expectations. One reason is a lack of user-based personalization; this leads to a mismatch between the displayed product and a patron's demand or interest.

Furthermore, products depicted on-screen only be sorted or chosen by a fixed number of product-specific options. For example, portals allow selection of clothes only by color, texture etc. However, a user aspirant of buying clothes may not be beneficiary since several parameters that are important for the user to purchase items are not depicted on-screen. For example, temperature, the location where cloth can be worn, etc. are usually not present as options to be depicted on-screen. In another example, the information depicted on-screen concerning the available products is incomplete, e.g. clothes don't contain supplemental information whether they can lose color on washing or not. Therefore, customers make unnecessary assumptions while buying items. If unsatisfied, they return the products. The same in turn leads to the monetary loss incurred during shipment of the requested product.

At least one of the examples underlying phenomena behind the generation of the online product is the excessive-complexity of image generative models. An example content-generating AI and artificial neural network ANN based phenomenon is generative adversarial network (GAN) enabled generation of infinite products. Yet, as depicted aforesaid, a patron becoming bored of browsing a never-ending inventory is a rampant phenomenon. At least a reason as may be attributed is that the generation process is purely random. There is no mechanism of knowing which particular product a customer will like. As a result, the process has to be continued indefinitely.

Likewise, for any multimedia content generation system, the generated content items (audio, video etc.) during their generation rely more on the mechanics of the underlying technology and largely fail to take into account the human-preferences. As a result, the end products or media items are usually mechanically generated and it takes a lot of iterations for them to manifest the user-preferences into the end result.

Overall, the current content-generating systems lack a user-personalization appeal despite leveraging AI for content generation. There has been a long-standing gap between machines and humans. Neural networks learn complex patterns but don't know which ones are relevant to a human. On the other hand, humans can “look” at a pattern and select which ones they like. But definitely they cannot generate new things as quickly in their minds at the pace of electronics or a machine! In other words, humans can't describe their needs electronically.

In an example, neural network forming a part of AI learns complex patterns like shape, pose, texture etc. which are otherwise interpretable by a human. However, such concepts cannot be labelled as ground truths in a numerical format by a person. As a result, the machine learning techniques (e.g. supervised techniques) rely on humans to broadly annotate simpler concepts while devising ground-truths. This is so since shape, poses are a concept that humans understand. However, on the other hand, human cannot generate a numerical vector on the basis of his provided label and have to be compulsorily-assisted by machine (i.e. a neural network) to that effect, for example by methods such as hot-encoding.

There is a need to improvise content-generating models to enable a machine to learn using human-specific biases to generate patterns relevant for a human.

Overall, there lies a need to contribute towards a human-computer interface (HCI) as an attempt to integrate man with machine.

### SUMMARY

The disclosure is to provide an electronic device configured to render a change in content generated based on an interaction with a user, and a method for controlling thereof.

This summary is provided to introduce a selection of concepts in a simplified format that are further described in the detailed description. This summary is not intended to identify key or essential inventive concepts, nor is it intended for determining the scope.

The present subject matter refers content-generation method in a computing-environment based on generative adversarial network (GAN).

Provided herein is a device including: a memory configured to store a neural network model; and a processor configured to: receive a first user input, identify a first identified domain corresponding to the first user input among a plurality of predefined domains, distinguish, based on first information related to at least one domain attribute among a plurality of predefined domain attributes being included in the first user input, attributes of a plurality of images corresponding to the first identified domain, obtain at least one image included in the first identified domain and corresponding to the at least one domain attribute through the neural network model, and provide the at least one image as an output.

Also provided is a method including: receiving an external input for image-generation by an artificial neural network (ANN), the ANN configured to operate in respect of a first plurality of target domain attributes (TDA) for a target domain; shortlisting a second plurality of TDA from the first plurality of TDA based on the external input and one or more clusters associated with the first plurality of TDA; interpolating data within a latent space, wherein the latent space is based on the second plurality of TDA, wherein the interpolating comprises determining a direction of interpolation based on: (i) a sampling vector, wherein the sampling vector is determined based on at least one of: (a) the external-input or (b) said one or more clusters; and/or (ii) an automatically-learned relation within a first plurality of latent codes in the latent space for predicting latent codes; generating a second latent code based on the interpolating along the direction; and creating at least one image by the ANN based on the second latent code.

Also provided herein is a non-transitory computer readable medium storing instructions, the instructions configured to cause a computer to perform steps including: receiving a first user input; identifying a first identified domain corresponding to the first user input among a plurality of predefined domains; distinguishing, based on first information related to at least one domain attribute among a plurality of predefined domain attributes being included in the first user input, attributes of a plurality of images corresponding to the first identified domain; obtaining at least one image included in the first identified domain and corresponding to the at least one domain attribute through the neural network model; and providing the at least one image as an output.

To further clarify the advantages and features of embodiments, a more particular description of embodiments will be rendered by reference to specific embodiments thereof, which is illustrated in the appended drawing. It is appreciated that these drawings depict only typical embodiments and are therefore not to be considered limiting its scope. Embodiments will be described and explained with additional specificity and detail with the accompanying drawings.

### BRIEF DESCRIPTION OF THE DRAWINGS

These and other features, aspects, and advantages of embodiments will become better understood when the following detailed description is read with reference to the accompanying drawings in which like characters represent like parts throughout the drawings, wherein:

FIG. 1A is a view illustrating a method of controlling an electronic device according to an embodiment;

FIG. 1B illustrates method-steps in accordance with an embodiment;

FIG. 2 illustrates an implementation of the method-steps of FIG. 1, in accordance with an embodiment;

FIG. 3 illustrates an example control-flow diagram depicting a sub-process in accordance with an embodiment of the subject matter;

FIG. 4 illustrates another example control-flow diagram depicting a sub-process in accordance with an embodiment of the present subject matter;

FIG. 5 illustrates another example control-flow diagram depicting a sub-process in accordance with an embodiment of the present subject matter;

FIG. 6 illustrates another example control-flow diagram depicting a sub-process in accordance with an embodiment of the present subject matter;

FIG. 7 illustrates another example control-flow diagram depicting a sub-process in accordance with an embodiment of the present subject matter;

FIG. 8 illustrates an example implementation of the sub-process of FIG. 7, in accordance with an embodiment of the subject matter;

FIG. 9 illustrates another example control-flow diagram depicting a sub-process in accordance with an embodiment of the present subject matter;

FIG. 10 illustrates another example control-flow diagram depicting a sub-process in accordance with an embodiment of the present subject matter;

FIG. 11 illustrates an example implementation in accordance with an embodiment of the present subject matter;

FIG. 12 illustrates another example implementation in accordance with an embodiment of the present subject matter;

FIG. 13 illustrates another system architecture implementing various modules and sub-modules in accordance with the implementation;

FIG. 14 illustrates a computing-device based implementation in accordance with an embodiment of the present subject matter;

FIG. 15 illustrates an example implementation for manifesting results in accordance with an embodiment of the present subject matter;

FIG. 16 illustrates an example implementation for manifesting results in accordance with an embodiment of the present subject matter;

FIG. 17 illustrates an example implementation for manifesting results in accordance with an embodiment of the present subject matter; and

FIG. 18 illustrates an example implementation for manifesting results in accordance with an embodiment of the present subject matter.

Further, skilled artisans will appreciate that elements in the drawings are illustrated for simplicity and may not have been necessarily been drawn to scale. For example, the flow charts illustrate the method in terms of the most prominent steps involved to help to improve understanding. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having benefit of the description herein.

### DETAILED DESCRIPTION

It should be understood at the outset that although illustrative implementations of the embodiments of the present disclosure are illustrated below, embodiments may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching and illuminating some embodiments and their specific features and elements and does not limit, restrict or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having an ordinary skill in the art.

Embodiments will be described below in detail with reference to the accompanying drawings.

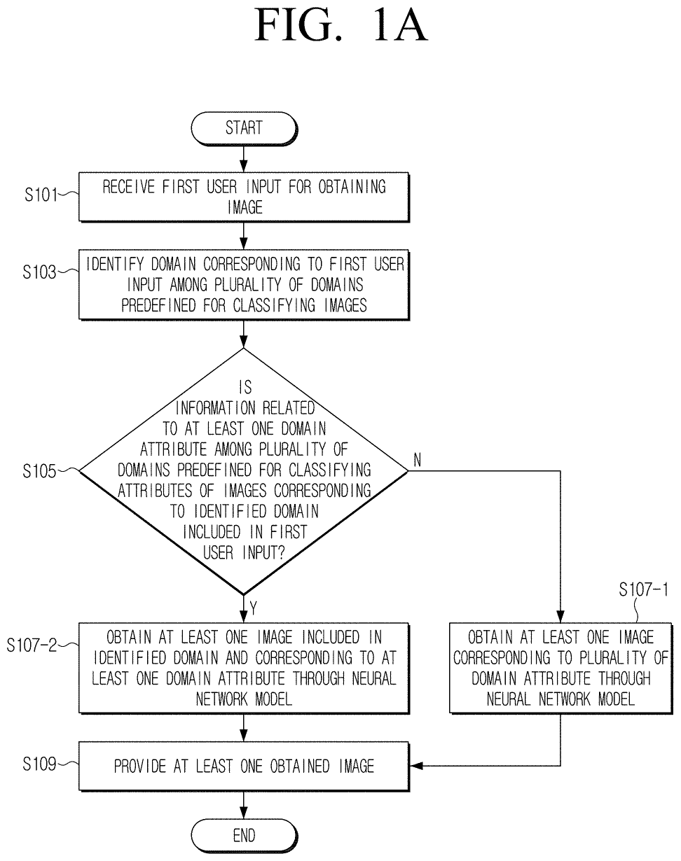

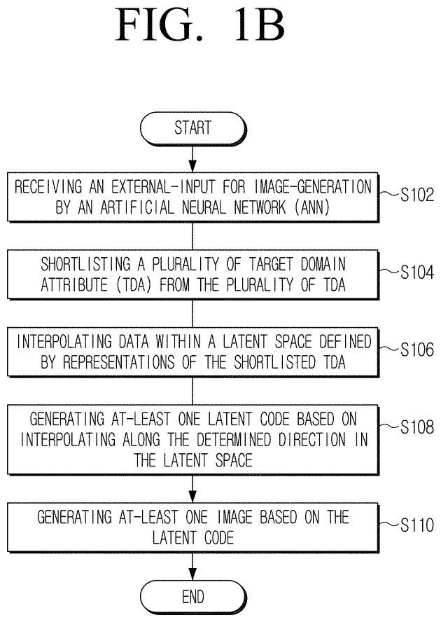

FIG. 1A is a view illustrating a method of controlling an electronic device according to an embodiment.

As illustrated in FIG. 1A, the electronic device according to the disclosure may receive a first user input for obtaining an image (S101).

The electronic device according to the disclosure is a device capable of acquiring an image using a neural network model, and any device configured to perform steps of a method of controlling as described below, regardless of its type. For example, electronic devices may be implemented in various types such as smartphones, tablet PCs, notebook computers, digital TVs, or the like. According to an embodiment, the electronic device is a server for providing a web site for selling products, and may be configured to generate various images of products using a neural network model.

The “neural network model” according to the disclosure refers to an artificial intelligence model including an artificial neural network, and may be learned by deep learning. In particular, the neural network model according to the disclosure may be generative adversarial networks (GAN) for generating an image.

The “first user input” may refer to a user input for obtaining an image according to the user's request. For example, it may be received based on a user touch input through a display of an electronic device, a user voice received through a microphone of the electronic device, or an input of a physical button provided in the device, a control signal transmitted by a remote control device for controlling the electronic device, or the like.

When the first user input is received, the electronic device may identify a domain corresponding to the first user input from among a plurality of domains predefined for classifying images (S103).

The term “plurality of domains” is a predefined classification criterion for classifying images that can be generated by a neural network model, and may be replaced with terms such as categories, classes, or the like. For example, when the electronic device according to the disclosure is implemented as a server for providing a website for selling products, and the neural network model is implemented to generate and output images for various types of products, the plurality of domains may include domains such as “jacket”, “plate” and “sofa” according to the type of product.

When information for selecting a specific domain from among the plurality of domains is included in the first user input, identifying the domain corresponding to the first user input means identifying the selected domain. For example, when the first user input includes information for selecting a product “jacket”, the electronic device may identify the domain “jacket” as a domain corresponding to the first user input. In describing the disclosure, the domain identified as corresponding to the first user input may be replaced with a term “target domain.”

The electronic device may identify whether information related to at least one domain attribute among a plurality of predefined domain attributes is included in the first user input in order to classify the attributes of images corresponding to the identified domain, and identify at least one domain attribute for obtaining at least one image according to the identification result.

The “domain attribute” is a detailed classification criterion that is predefined to classify attributes of images for each domain, and may be referred to as a lower concept to classify an upper concept of the domain. For example, a domain attribute for the domain “jacket” may include detailed classification criteria for classifying images for various types of jackets, such as “color”, “material”, “brand”, or the like. In describing the disclosure, the term “domain attribute” may be replaced with a term “target domain attribute (TDA).”

“Information related to the domain attribute” is used as a term for generically referring to information corresponding to a predefined domain attribute among information included in the first user input. Specifically, the information related to the domain attribute may include at least one of direct information and first indirect information.

The “direct information” refers to information for directly selecting at least one domain attribute from among the plurality of predefined domain attributes. For example, when information “red jacket” is included in the first user input, the information “red” may be direct information for selecting a color “red” from among the plurality of domain attributes.

The “first indirect information” is not information for directly selecting at least one domain attribute from among the plurality of predefined domain attributes, but is information related to at least one domain attribute and information that may be mapped to at least one domain attribute. For example, when the first user input includes information such as “a jacket to wear in Russia”, the information “Russia” may be first indirect information for selecting a material called “thick material” from among the plurality of domain attributes. In describing the disclosure, the term “first indirect information” may be distinguished from “second indirect information” as described below, and may be replaced with a term “source domain attribute (SDA)”.

As described above, when it is identified whether information related to at least one domain attribute is included in the first user input, the electronic device may identify a domain attribute for obtaining at least one image according to the identification result.

Specifically, if the information related to at least one domain attribute is not included in the first user input (S105-N), the electronic device may obtain at least one image corresponding to the plurality of domain attributes through a neural network model (S107-1). In other words, if the information related to at least one domain attribute is not included in the first user input, the electronic device may randomly combine all of the plurality of predefined domain attributes to distinguish images corresponding to the identified domain, and generate at least one image.

Meanwhile, if information related to at least one domain attribute is included in the first user input (S105-Y), the electronic device may be included in the domain identified through the neural network model and obtain at least one image corresponding to the at least one domain attribute (S107-2). In other words, when information related to at least one domain attribute is included in the first user input, the electronic device may not randomly combine all of the plurality of domain attributes, but instead identify at least one domain attribute for obtaining at least one image based on information related to at least one domain attribute, and may generate at least one image based on only the identified at least one domain attribute.

Specifically, when the first indirect information is included in the first user input, the electronic device may map the first indirect information to a domain attribute predetermined as corresponding to the first indirect information. In addition, the electronic device may identify at least one domain attribute including a domain attribute corresponding to the direct information and at least one domain attribute including domain attributes mapped to the first indirect information, and obtain at least one image corresponding to at least one domain attribute identified by using the neural network model.

For example, if the first user input includes the information “red jacket to wear in Russia”, the electronic device may obtain information such as “temperature of Russia”, “altitude of Russia”, “wind speed of Russia”, “weather forecast of Russia”, or the like based on the first indirect information, and map the first indirect information “Russia” to the domain attribute of “thick material” based on the obtained information. In addition, the electronic device may obtain at least one image corresponding to at least one domain attribute including a domain attribute of “red” corresponding to direct information of “red” and a domain attribute of “thick material” corresponding to first indirect information of “Russia.”

When at least one image is obtained as described above, the electronic device may provide the at least one obtained image (S109). Specifically, the electronic device may display the obtained image on the display of the electronic device, or may be displayed on a display of the external device by transmitting the obtained image to an external device connected to the electronic device.

According to the embodiment described above, the electronic device may not only belong to the domain of the image that the user wants to obtain based on the user input through the neural network model, but may also generate images having the domain attribute desired by the user and provide the images to the user. In particular, even when information indirectly related to the domain attribute (first indirect information) is included in the user input, the electronic device may map the indirect information to the domain attribute, and provide an image with detailed attributes desired by the user to the user.

In particular, when the electronic device according to the disclosure is implemented as a server for providing a web site for selling products, and the neural network model is implemented to generate and output images for various types of products, the electronic device may generate a new image for the product having an attribute that the user desires to buy, and provide the image to the user, thereby remarkably improving user convenience.

Meanwhile, according to an embodiment of the disclosure, the electronic device may identify whether at least one image obtained through the process described above meets the user's intention.

Specifically, when at least one image is obtained, the electronic device may obtain second indirect information related to the at least one domain attribute from the at least one image. The “second indirect information” is not information for directly selecting at least one domain attribute from among the plurality of predefined domain attributes, like the first indirect information, but is information related to at least one domain attribute, and information that can be mapped to at least one domain attribute. However, the first indirect information is to refer to information included in the first user input, whereas the second indirect information is to refer to information obtained from at least one image obtained through the neural network model.

When the second indirect information matches the first indirect information, the electronic device may provide at least one image. In other words, as a result of obtaining at least one image based on the first indirect information included in the first user input, if the second indirect information obtained from the at least one image matches the first indirect information included in the first user input, it may indicate that an image that meets the user's intention is obtained, and thus the electronic device may provide at least one obtained image to the user.

Meanwhile, if the second indirect information does not match the first indirect information, the electronic device may retrain the neural network model. The retraining the neural network model may include a process of adjusting a domain attribute corresponding to the first indirect information so that the second indirect information can be matched with the first indirect information. In other words, as a result of obtaining at least one image based on the first indirect information included in the first user input, if the second indirect information obtained from the at least one image is not matched with the indirect information included in the first user input, it may indicate the image matching with the user's intention is not obtained, so the electronic device may intend to obtain an image corresponding to the user's intention by adjusting the domain attribute corresponding to the first indirect information to another domain attribute.

Meanwhile, according to an embodiment of the disclosure, the electronic device may reflect the user's feedback on at least one image obtained through the process described above.

Specifically, when a second user input including the user feedback information on at least one image provided to the user through the process described above is received, the electronic device may adjust at least one domain attribute based on the feedback information, and obtain at least one image corresponding to the adjusted at least one domain attribute.

The “feedback information” may include positive feedback information on a first image among at least one image and negative feedback information on a second image among at least one image. In this case, the adjusted at least one domain attribute may include one or more domain attributes excluding a plurality of domain attributes corresponding to the second image among the plurality of domain attributes corresponding to the first image.

In the above, the embodiment of the disclosure has been briefly described with reference to FIG. 1A. Hereinafter, a detailed method for technically implementing various embodiments of the disclosure including the embodiments described above will be described.

FIG. 1B illustrates method-steps in accordance with an embodiment of the present subject matter. The method comprises image generation method in a computing-environment based on artificial intelligence (AI) based technique. In an example, the ANN refers a Generative adversarial network (GAN) for image generation.

The method comprises receiving (step S102) an external-input for image-generation by an artificial neural network (ANN). The ANN is configured to operate in respect of a plurality of target domain attributes (TDA) for a target domain. The ANN configured to generate images in the target-domain is defined by a plurality of characteristics such as disentangled TDA representations for rendering a starting point in the latent space for content or image generation. A plurality of initialized vectors is defined by one or more of the cluster sampling vector (CSV), and a cluster preference vector (CPV).

In an implementation, receiving the external input comprises receiving one or more user-label electronically or acoustically for generating images, wherein such user-label is optionally accompanied with one or more source domain attributes. The user-label is mapped with one or more target domain attribute to facilitate said shortlisting of TDA, while the one or more accompanying source domain attributes are mapped with the shortlisted TDA. In other implementation, the receipt of the external input comprises receiving the external input as an automatically-generated trigger based on a prediction of the intermediate labels within the latent space by a machine based on existing latent-codes. Based thereupon, the plurality of TDA is disentangled based on said predicted intermediate labels till attainment of a threshold defined by a user-feedback as has provided earlier.

In an example, based on the external input, one or more source domain attributes are filtered based on a criteria defined by a combination of causality criteria and correlation criteria. The filtered source domain attributes are modelled into the plurality of the target domain attributes (TDA).

Further, the method comprises shortlisting (step S104) a plurality of target domain attribute (TDA) from the plurality of TDA based at least one of said external input and one or more clusters associated with said plurality of TDA. The shortlisting of the TDA further comprises identifying one or more clusters within the latent space associated with shortlisted TDA and based thereupon identifying one or more cluster preference vector (CPV). The shortlisted TDA may be referred to herein as a second plurality of TDA.

A user preference vector (UPV) is computed based on the received external input comprising the user label and optionally source domain information. The plurality of shortlisted TDA relevant to the external input are ranked by combining the cluster preference vector (CPV) and the UPV. The ranked and shortlisted TDA and one or more combinations thereof are defined for initiating the interpolation within the latent space.

Further, the method comprises interpolating (step S106) data within a latent space defined by representations of the shortlisted TDA. The direction of interpolation is determined based on a sampling-vector computed based on at least one of: (a) the external-input and (b) said one or more clusters. The computation of the current sampling vector is based on the derivation of a first vector as a user sampling vector (USV) from the external input. A derivation of a second vector as a cluster sampling vector (CSV) from said clusters related to the shortlisted TDA. The first and second vector is combined to result in the current-sampling vector. In another example, the computation comprises computing a user sampling vector (USV) from the external input and a mapping drawn between the source domain attribute and the target domain attribute. The USV, and a sampling vector of the identified cluster are combined to provide a resultant sampling vector. Based on the resultant sampling vector, one or more clusters are updated based on said resultant sampling vector. The one or more clusters are defined by a cluster comprising said shortlisted TDA, and one or more clusters linked to at least one TDA out of the shortlisted TDA.

In an example, the direction of interpolation is defined based on a statistical running average of the historically computed sampling vectors based on user input and said one or more clusters. Specifically, the logged sampling vectors are aggregated with a current computed sampling vector to result in an aggregated-vector through weighted-averaging. A pattern of variation among the existing latent codes is based on said automatically-learned relation within said latent space through a neural network. An aggregated direction is derived based on the directions associated with the aggregated vector and the computed pattern to thereby result in a federated-update to the direction of interpolation.

Further, the method comprises generating (step S108) at least one latent code based on interpolating along the determined direction in the latent space. A magnitude and direction associated with the resultant sampling vector is determined; and a plurality of latent codes are generated in the latent space by interpolating along the direction of resultant sampling vector based on the determined magnitude. The interpolation of the latent-space based on the external input comprises resolving said resultant sampling vector into a unit directional vector and corresponding magnitude, and generating multiple latent codes along the unit directional vector based on one or more magnitudes.

In an example, the direction of the latent space is determined based on an automatically-learned relation within the latent codes in said latent space for predicting latent codes. The interpolation of the latent space based on the automatically-learned relation within said latent space comprises searching, through the subspace defined by the shortlisted TDA, one or more latent-codes configured to generate images in the target domain. Also, a neural-network is trained to compute a relation among said latent codes within the subspace to thereby enable prediction of additional latent codes based on the computed relation.

Based on the created latent codes, at least one image is generated (step S110) by said ANN. Further to the image creation, the external input as further received comprises receiving multiple user-feedbacks pertaining to the images generated as a part of the latent space interpolation. Within the interpolated latent space, optimal vector values for the user are calculated for a particular combination of the target domain attributes as one or more of: an optimal user sampling vector (USV) based on an average distance associated with respect to positive feedback, and an optimal user preference vector (UPV) obtained based on a relation between positive feedback and negative feedback.

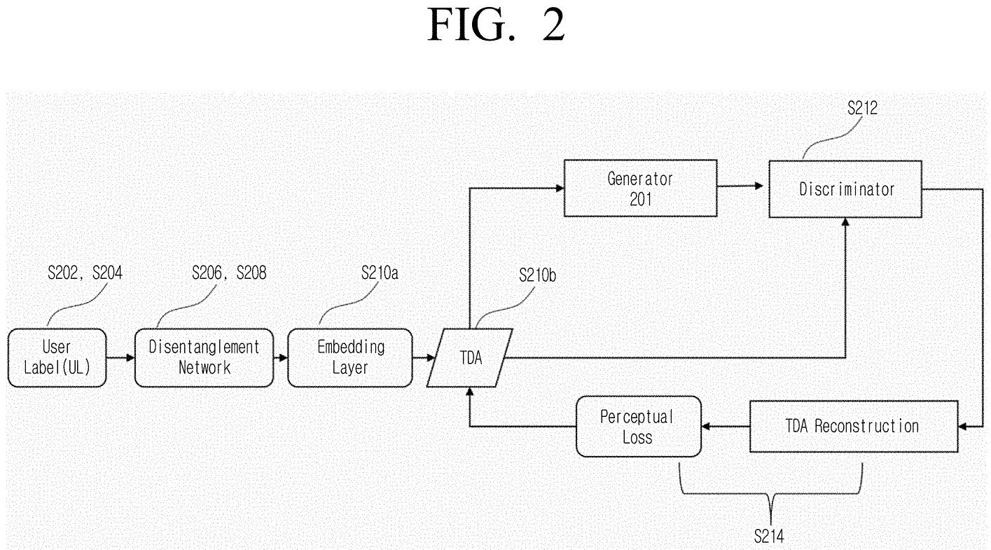

FIG. 2 illustrates a training phase of the AI model based ANN in an embodiment of the present subject matter and corresponds to step S104 of FIG. 1B.

Step S202 represents the gathering of a plurality of user labels for each image in the target domain.

Step S204 represents conversion of labels to numerical-format, for example, executed through one hot-encoding. This is followed by aggregation of user labels into a numeric feature vector.

Step S206 represents obtaining the feature vector based on the numeric feature vector of Step S204. The number of conditional labels (attributes) in the target domain is pre-defined. Corresponding to each target domain attribute, a feature-vector is obtained from the neural network.

Step S208 represents selectively masking the outputted feature-vector in step 206 to isolate a certain number of target-attributes, which are relevant to the image formation. E.g. out of N numbers of target attributes, 2^{N} combinations are possible.

Step S210 represents training (step S210a) an embedding-layer forming a part of a neural network to project the 2^{N} combinations to a common subspace. Considering the present example, for N TDA's there are N rows that are chosen in 2\hat{ }N combinations. Since the embedding layers correspond to an embedding matrix of rows and columns, the length of each row at least denotes the dimensions of the common subspace. The output feature map is fed as an input (step S210b) to an image generator 201 forming a part of the generative adversarial network (GAN).

Step S212 represents operation at the discriminator's end, wherein the reconstruction-loss helps to regenerate the target domain attributes.

Step S214 represents the regeneration of multiple sets of target-domain attributes with the same accuracy. To isolate or shortlist one of these sets, the user labels are reconstructed by extending the reconstruction loss to the user labels.

Overall, the aforesaid steps are continued and training is done until the best representations of the relevant target domain attributes are revealed. This forms the attributes along which the latent space is to be varied to generate user experiences. Further, the trained GAN as obtained is capable of generating images or any other multimedia content based on the latent-code forming a part of the latent space.

As may be understood, the artificial intelligence AI model as obtained by training means that a predefined operation rule or artificial intelligence model configured to perform the desired feature (or purpose) is obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

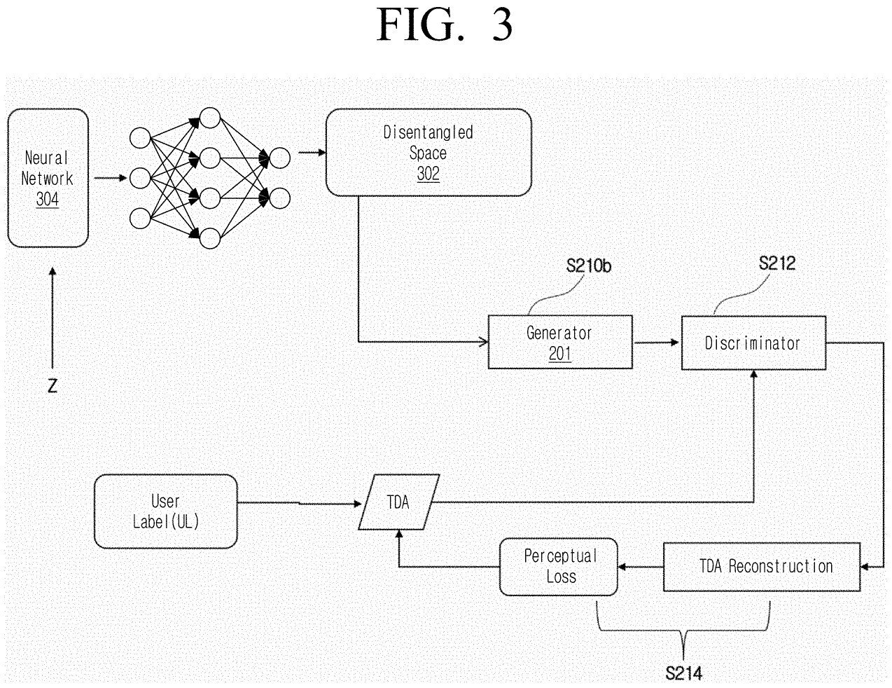

FIG. 3 illustrates another training phase of the AI model based ANN in an embodiment of the present subject matter and corresponds to step S104 of FIG. 1B.

In an example, the random noise (Z) obtained through a probability distribution function (PDF) to generate images is processed as a disentanglement-space 302. Generative architectures 201 traditionally take a random noise vector as an input to create variations in the target domain. However, randomly sampling from an unknown probability distribution does not allow learning of representations that are directly responsible for interpolation. Accordingly, in accordance with the present subject matter, the input noise is fed to a neural network 304 that is transformed into disentangled space associated with complex level features. Based thereupon, an input is rendered to the generative model, thereby in turn giving representations directly responsible for interpolation and image generation during the training phase as well as inference phase.

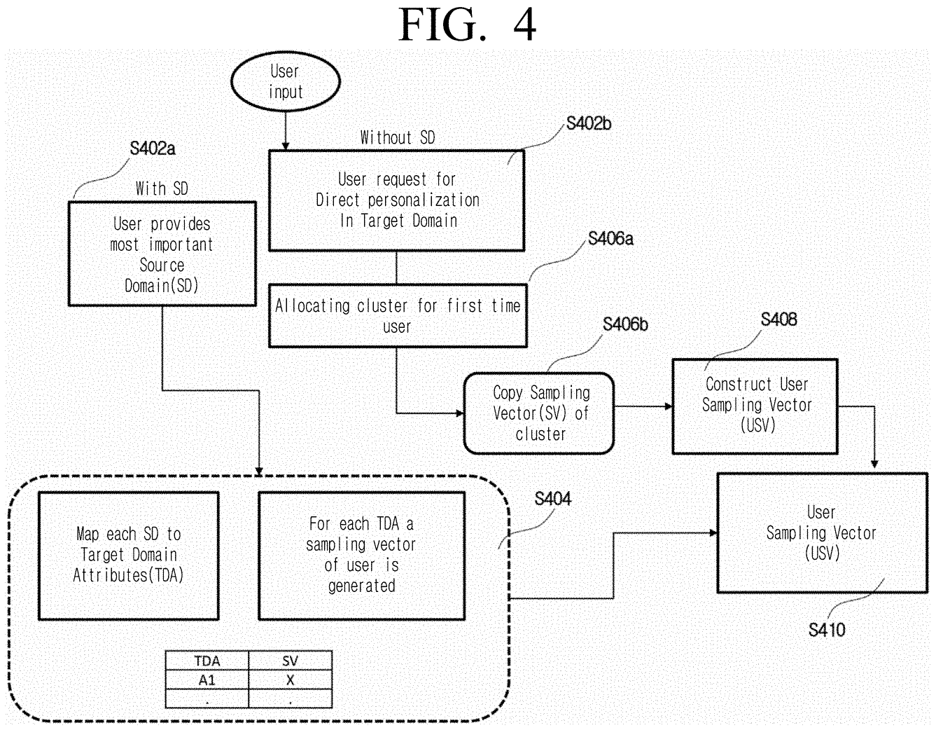

FIG. 4 illustrates mapping user input to target-domain attributes in accordance with an embodiment of the present subject matter and corresponds to step S102 of FIG. 1B.

Step S402 represents receipt of external user input with or without source domain (SD) attribute. In case of receipt of source domain (SD) attribute from the user in step S402a, the control flow proceeds to step S404. Else in case of non-receipt of SD attribute in step S402b, the external input is considered as a user request for direct personalization in target-domain. In such a scenario flow proceeds to step S406.

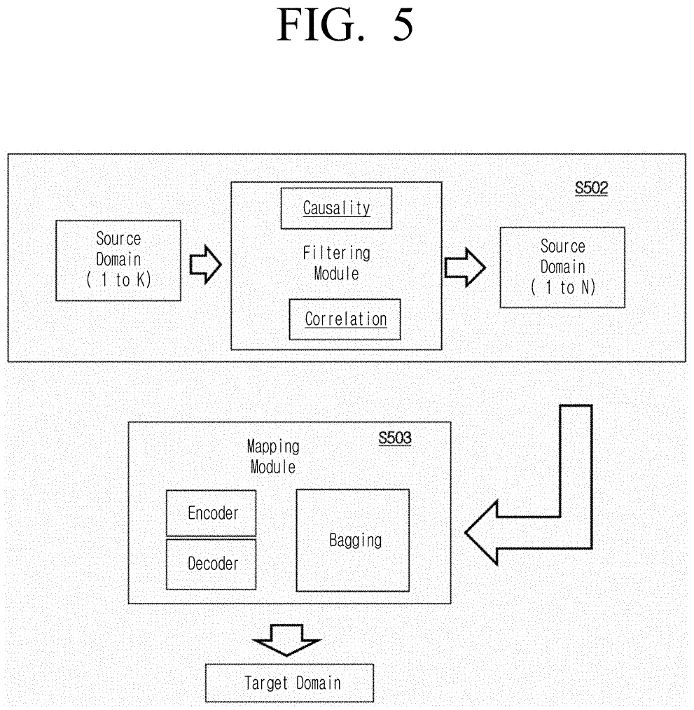

At step S404 the source domains are mapped with target domain attribute (TDA) based on the description in FIG. 5. Upon identification of corresponding TDA, a vector is calculated with respect to each TDA. The vectors are normalized such that each vector is a unit vector and a set of such unit vector are deemed as a user sampling vector (USV) as represented in step S410.

At step S406a, a clustering logic that assigns a first-time user associated with the external input to a particular cluster within the latent space. However, in case the user is already associated with a cluster, then the control flow transfers to step S406b.

At step S406b, a predefined sampling-vector associated with the cluster associated with the user (providing the external-input) is fetched.

At step S408, the user input as provided is converted into a vector, for example through hot encoding. Based thereupon and the vector fetched in step S406, an equivalent vector is computed and deemed as the user sampling vector (USV) as represented in step 410.

FIG. 5 illustrates mapping source-domains to target-domain attribute in accordance with an embodiment of the present subject matter and corresponds to step 102 of FIG. 1B.

Step S502 corresponds to a filtering-process defined by causality filtering that is performed by a human entity by providing the source domain attributes that to his/her knowledge are linked with the target domain attributed. As a part of correlation-mechanism, a correlation between source and target domain is established by fitting a hypothesis on the (X, Y) data points of the domains. The source domains that yield accuracy greater than a particular threshold (i.e. 1 to n) are filtered or shortlisted from the inputted source domains (1 to k). By executing the intersection of causality and correlation modules, the source domains exhibit bijective property. In other words, a bijective relationship is achieved between the representations of source and target domains by appropriating a fundamental pre-defined condition for uncorrelated domain reconstruction.

Step S503 corresponds to establishing relationships between source domains and target domain attributes. Once the source domains are chosen, it becomes necessary to model them. In a generic sense, each source domain holds one-to-many mapping with all the target domain attributes. However as the number of source domains increases, modelling such one-many relationships increases the number of required model parameters linearly. To address such problem, a common neural network is obtained by the combination of the Encoder and Decoder. The common network is trained to learn such relationships irrespective of the number of source domains.

The Mapping module as depicted in step S503 comprises two components called Multi-Modal Encoder and Multi-Modal Decoder. As a part of the operation of the Mapping Module, a dataset or look up table containing the source domain and corresponding values in the target domain is fetched as a precursor. A first-phase of operation of the mapping module is the training phase.

The encoder/decoder portion of the network contains a separate ANN network for each source domain. The source domain values are translated to common target domain representations by the encoder through “Bootstrap aggregating” or Bagging that enables a later reconstruction at the decoder end. The “bagging” refers an aggregator-network that learns to mix data from multiple modalities and project its output feature maps to a same common target domain representations step. The “amount” of information from each source domain to be mixed at each level of the common-network is kept as a learnable-parameter that is trained during an optimization phase of the training process.

Post training, the “separate networks” for each modality in the encoder may be removed, while the individual-decoders for each source domain are kept. This enables the network to reconstruct the multi-modal source domains as and when required.

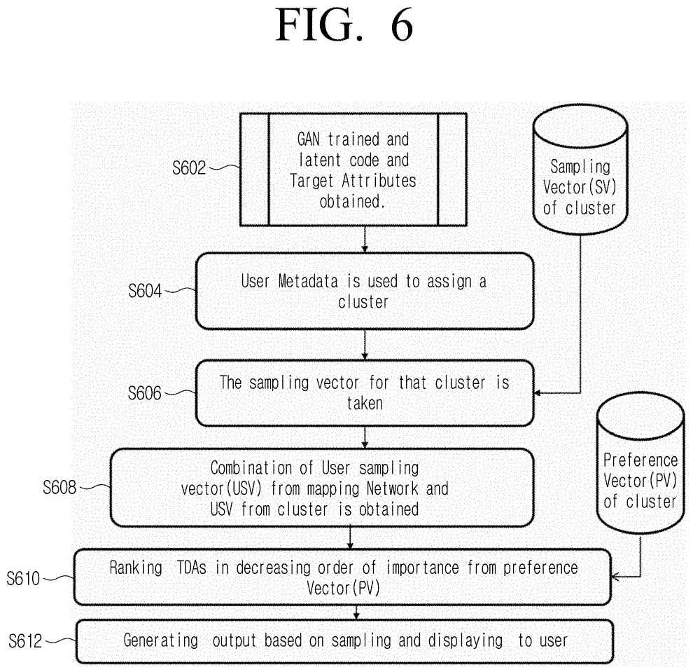

FIG. 6 illustrates the generation of target-domain samples based on external input in accordance with an embodiment of the present subject matter and corresponds to steps 106, 108 of FIG. 1B.

Step S602 illustrates a state achieved upon having undergone stages corresponding to FIG. 4. In other examples, the present state in step S602 represents a default state of the ANN which may be deployed without training. At this stage, the trained ANN network or GAN possesses the following two capabilities:

(i) Generation of diverse and realistic images in the target domain and

(ii) Disentangled representations of the target domain attributes whose combination yields the external label provided to the generator.

In other words at the step S602 represents a condition wherein a generative model has been trained on target domain and disentanglement of target domain attributes has been done. Combinations of target domain attributes conditions the generator to produce variations in a smaller cluster or subspace. The aforesaid capabilities enables the trained or configured ANN to produce the subsamples in the target domain that best describes a particular combination of the target domain attributes.

At step S604 a particular cluster of TDAs (as mentioned in step S602) is chosen. The cluster is associated with the external-input provided by the user at step S402 of FIG. 4. The external input may be a plain request by a user for example “show me shirt designs” and thereby corresponds to a direct request for personalization in target domain. In other example, the request may be accompanied with SD attributes and corresponds to an indirect personalization request in target-domain. An example of indirect personalization with SD attributes may be a request “show me the shirt for wearing in high temperatures at Africa.”

At step S606, the sampling vector associated with chosen cluster in step 604 is selected.

At step S608, the user sampling vector obtained in step 412 of FIG. 4 is combined with the cluster sampling vector of step 606 to give a final sampling vector. One or more clusters may be updated based on said resultant sampling vector, wherein such clusters relate to shortlisted TDA. The sampling vector is decomposed into a unit-directional vector and corresponding magnitude. In an example, the previously logged sampling vectors may be aggregated with a current computed sampling vector to result in an aggregated-vector through weighted-averaging. A pattern of variation among the existing latent codes is determined based on an automatically-learned relation within said latent space through a neural network. Accordingly, an aggregated-direction of interpolation may be derived based on the directions associated with the aggregated vector and the computed pattern to thereby result in a federated-update to the direction of interpolation.

At step S610, the preference vector of the chosen one or more clusters in step 604 and a user preference vector computed from the external input are combined to generate rankings of the TDA which are relevant to a user. Appropriate number of K out of N target domain attributes are selected. A random number of M target attributes out of K attributes are chosen. Disentangled representations of M attributes are kept and rest N-K are masked to yield a label for the generator. As a part of verification drive referred as latent traversal preparation phase, the generative model is put in the evaluation mode with conditioning applied to it.

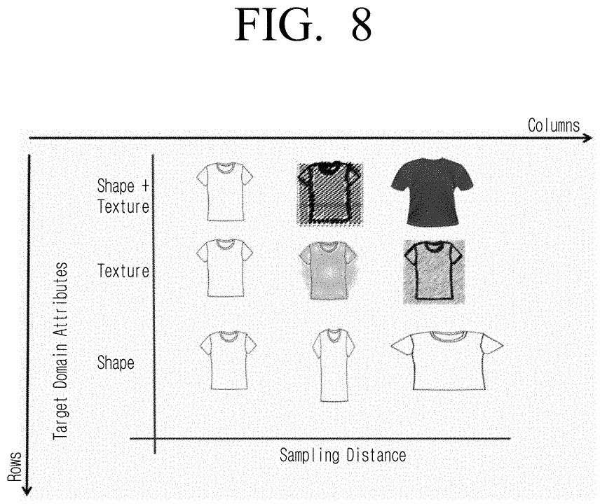

At step S612, the interpolation within the latent space is performed along a sampling direction as determined from the resultant sampling vector of step S608 to generate a plurality of latent codes and thereby the image. The images have been shown as arranged in FIG. 8.

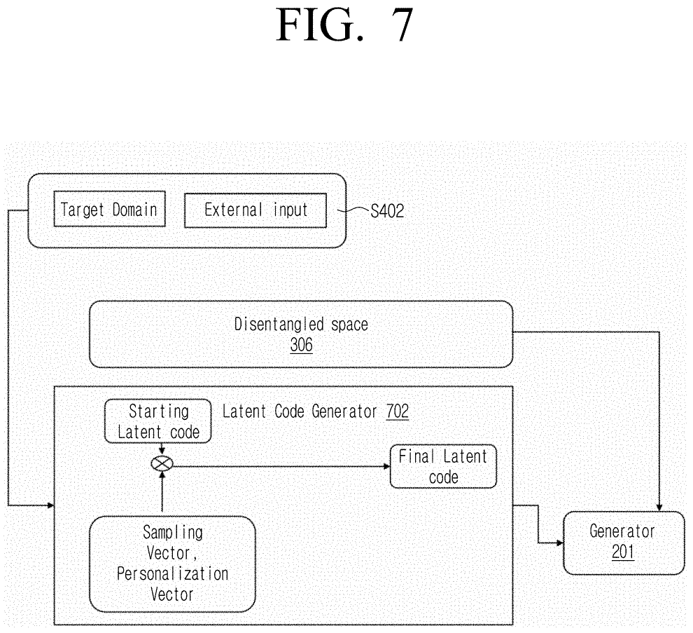

FIG. 7 illustrates the interpolation of data within the latent space to generate images in accordance with step S612 in accordance with an embodiment of the present subject matter. As may be understood, the latent code corresponds to a point in the latent space that isolates a particular image generated by the GAN. Latent code formation takes place by adding a sampling vector to a starting point in the latent space. Due to the disentangled TDA representations, a separate sampling vector is modelled for each TDA.

The user/cluster sampling vectors are combined (as referred in FIG. 6) to give a final sampling vector. The sampling vector is decomposed into a unit directional vector and corresponding magnitude. By keeping the magnitude constant, multiple latent codes along the direction of the sampling vector are obtained in a latent code generator 702 from external input as provided by the user vide step 402 of FIG. 4. Each of these latent codes along with the learned features in the disentangled space are sent to the generator for generating an image.

In other example, the latent codes may be generated automatically without any external input based on the prediction of the intermediate labels within the latent space based on existing latent-codes. For such prediction, the subspace defined by the shortlisted TDA is automatically searched for defining one or more latent codes configured to generate images in the target domain. A neural network may be trained using a neural-network to compute a relation among said latent codes within the subspace to thereby enable prediction of additional latent codes based on the computed relation. Thereafter, the plurality of TDAs are disentangled based on said predicted intermediate-labels till attainment of a threshold defined by a user-feedback. The shortlisted TDA are obtained based on the disentangled TDA for enabling interpolation.

FIG. 8 illustrates a diagram explaining the latent-space interpolation with respect to example user-input, in accordance with the present subject matter and corresponds to step S110 of FIG. 1B.

In an example, the GAN may be trained by virtue of FIG. 3 in terms of “shirts” as the target-domain. Through the training of FIG. 3, the best factors like shape, color, texture are identified that directly impact the shirt formation. By the end of this phase, the GAN achieves the capability to generate a shirt for any user (say Mr. Kim) given only a number (i.e. a shirt, brown shirt, white shirt) as an external input.

Based on FIG. 4, the external input provided by the user (i.e. request for shirt image generation) is received in real-time which is mapped with the target domain. In addition, as a part of providing indirect personalization, the user may also provide source domain attributes by telling that he wants to buy a shirt for a friend in Russia. The indirect SD factors like Russian Weather are mapped by the mapping network of FIG. 4 and FIG. 5 to the direct TD factors like shape, color etc. which were identified during the training phase depicted in FIGS. 2 and 3.

Accordingly, a plurality of images are generated based on interpolation of data within the latent space as the output. For latent space interpolation, the decision to choose the target domain attributes is taken by the preference vector mentioned in FIG. 6 and FIG. 7 that ranks target domain attributes in decreasing order of importance. Now with respect to a particular target domain attribute, the important images along the latent space are determined based on the sampling vector. As may be understood, a sampling vector determines the direction along which the latent space interpolation is done. Further, apart from having an individual entity, each user has a group identity as well, i.e. might belong to a larger group. Accordingly, the preference and sampling vector are considered both at user and the cluster level.

Now coming to the representation shown in FIG. 8, the same illustrates concepts of latent space interpolation with-respect to the external input or the user label “shirt.” As shown, the interpolation can take multiple properties like texture, shape into account.

The preference vector governs the decision about which particular combination of properties are taken for a user. In an example, the hierarchy or ranking of rows is executed in accordance with the preference vector. Each ranked row illustrates which is the property in the latent space that varies on interpolation and accordingly represents the target domain attributes (i.e. texture, shape).

With respect to a particular row like “shape”, infinite images may be generated across the columns based on a sequence decided by the sampling vector. The sampling vector determines the decision about what should be the distance between any two consecutive images shown to a user. In other example, the row may also depict a TDA which may not be readily interpretable to a human-being but easily decipherable by a machine. In an example, such specific TDAs may be combination of various TDA's such as “shape+texture+color+temperature.”

Further, in an example, the present images may also be ranked. Images may be ranked especially when interpolation stops, because at that time user becomes satisfied with the last image as produced. Accordingly, the column associated with the “liked” image is a last-column and may be ranked such that rows may be arranged in a desired-sequence. The top-row in the ranked column depicts the “liked” image. The images or rows down the hierarchy depict a decreasing order of closeness with the liked image. In other words, the last-ranked column may be simply referred as outcome of iteratively done interpolations, i.e. “iterative interpolation outputs.”

Overall, the process of generation of images through user labels as depicted in the description of FIG. 2 till FIG. 7 may be summarized as follows:

(i) Learning complex concept through a neural network.

(ii) Obtaining a broad user feedback for that concept.

(iii) Mapping user feedback with the internal feature vector of the complex concept in (i) to construct a training example.

(iv) Guiding further training of the network in an unsupervised/partially supervised manner till a particular accuracy threshold is reached.

This phenomenon enables labelling complex concepts also by bridging the gap between the neural network and human representations. The description of FIG. 2 till FIG. 7 refers mapping complex learned concepts with broad user feedback. The forthcoming figures refer the content or image generation based on iterative feedback.

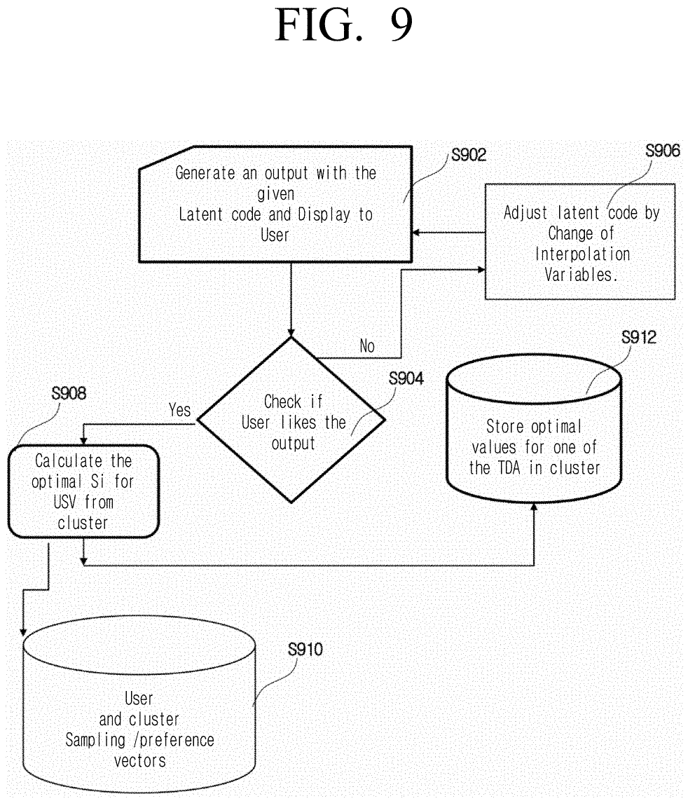

FIG. 9 illustrates generation of target domain samples based on user-feedback. Overall, the present figure illustrates the mechanics of image generation driven by user feedback and thereby identifies relevant samples out of a variety of generated images.

Step S902 refers image generation in accordance with the latent space interpolation in FIG. 7 and FIG. 8

Step S904 corresponds to obtaining a like or dislike of the user with respect to a current generated image of the object as done. In case of dislike, the control flow proceeds to step S906, otherwise in case of “like” the control flow proceeds to step S908.

Step S906 represents adjustment of latent-code and thereby varying the interpolation variables to generate fresh images through further done interpolation. By changing the sampling vector of one of the target domain attributes, variations in target domain are provided to the user.

The control flow transfers back to step 904 to ascertain the user-opinion. The back and forth operation between steps S904 and S906 continues until the user is satisfied by the images being produced in the target domain and control flow transfers to step S908.

At step S908, in case of ‘like’ or positive feedback by the user, a sampling-distance as employed to achieve the liked image is noted to compute the optimal sampling vector for a user for the particular combination of target domain attributes. More specifically an optimal user sampling vector (USV) is determined based on an average distance associated with respect to positive feedback. For example, an average distance between any two positive feedbacks is used to compute the optimal sampling vector for a user for a particular combination of target domain attributes. In addition, an optimal user preference vector (UPV) is obtained based on a relation between positive feedback and negative feedback. In an example, the ratios of positive feedback to negative feedback are used to obtain the preference vector of a user for an attribute. In other examples, the preference-vectors may be also be obtained from any other degree of the change as associated with the user feedback, i.e. first order derivative, second order derivative. Overall, the user satisfaction is calculated as per the rate of positive responses collected from the user feedback. Further, the positive feedback may be construed to denote any feedback based logic that provides the aforementioned system with an indication to pause the generation process in the target domain.

In other example, a statistical running average of the historically computed sampling/preference vectors is also considered for said calculation of optimal vectors. More specifically, the logged sampling vectors are aggregated with a current computed sampling vector to result in an aggregated-vector through weighted-averaging. The same also holds applicable for optimal preference vector calculation.

At step S910, the optimal vectors as calculated in step S908 are stored.

At step S912, based on the optimal sampling vectors, the TDA are updated that in turn leads to an update of the corresponding clusters.

Overall, the target sample generation in accordance with FIG. 9 allows the mixing of direct TDA factors to form the shirt. The user likes the formed shirt or not. By such iterative feedback, the system obtains the ideal amount of each direct factor that needs to be mixed. Moreover, the generation takes place based on iteratively received feedback, and no personal data may be required.

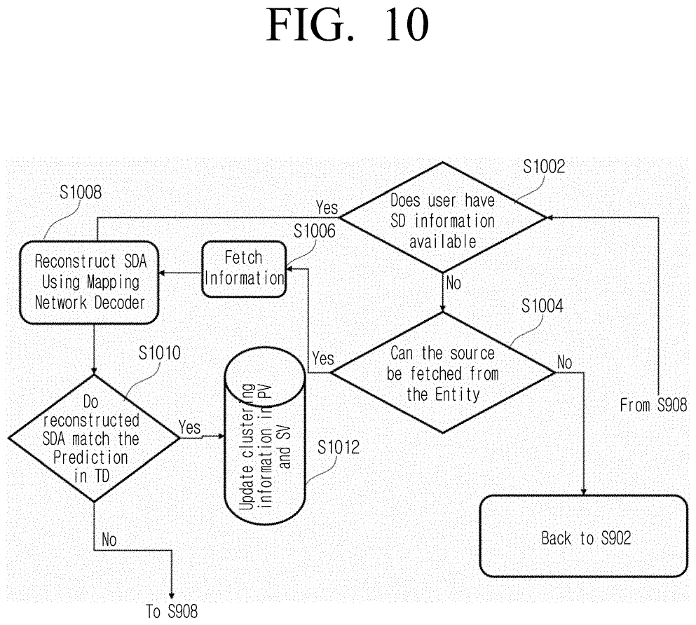

FIG. 10 illustrates the reconstruction of source domain attributes where the target domain sample is used to reconstruct the information in source domains. The requirements for said reconstruction may be the disentangled TDA, and an optimal sample in Target domain generated through the user feedback in FIG. 9. Accordingly as a part of reconstruction-phase, the target domain-sample is used to reconstruct the information in source domains.

At step S1002, the optimal sampling vector for the user as calculated in FIG. 9 as associated with the “liked” target domain sample is obtained. In other examples, the calculated optimal vector values specific to the user and the shortlisted TDA provides an aggregated feature vector.

At step S1004, it is checked if the source domain information is present within the optimal vector. If not, then the control transfers to step S1006 such that source domain information may be attempted to be fetched from the name-entity corresponding to the optimal vector and target domain sample. Once the source domain information is fetched with success, the control transfers to step S1008. However, in case of fetching failure, the control transfers back to FIG. 9 at step S902 wherein the target domain sample is regenerated with variations. Once the varied target domain sample is liked in step S908, then the control flow is communicated to step S1002.

At step S1008, the information for each of the plurality of source domains is reconstructed based on the aggregated feature vector through a decoder forming a part of the common network as depicted in FIG. 5.

At step S1010, the reconstructed information is compared with the source domain information received within the user input to compute the efficiency of the shortlisted TDA.

At step S1012, the efficiency may be found as optimum. In such a scenario, the clustering information associated with the preference vector (PV) and sampling vector (SV) is updated.

At step S1010, the efficiency may also be found as not-optimum. In such a scenario, the shortlisted TDA is updated to augment the efficiency and based thereupon one or more of the USV, UPV, CSV, CPV and at least one cluster associated with the TDA are updated. More specifically, the step 1010 leads to transfer of control to FIG. 9 and thereafter resolved into following sub-steps:

a) Receiving another user feedback vide step S904 for augmenting said efficiency;

b) Updating the shortlisted TDA;

c) Optimization of the sampling vector for the user for the shortlisted TDA vide step S908 followed by updated cluster sampling vector & the cluster preference vector. Optionally, updating of at least one cluster related to one or more of the shortlisted TDA may be performed; and

d) Communication of the optimized-vectors to the step S1002 to reinitiate the procedure of FIG. 10.

The present figure at least enables that for the newly constructed “shirt” liked by the user, the weather conditions are predicted where the shirt might be worn. This is compared with the actual weather of the desired location to check if the results will be useful for the user.

Overall, an example real-life benefit emanating from the description of preceding figures is as follows:

[1] Infinite shirts can be generated based on combinations of existing shirts in the inventory.

[2] Once a shirt is formed, a user's feedback is collected. This enables fine-tuning of the generated shirts according to user's preferences, which is a step beyond traditional similarity and retrieval approaches on e-commerce websites.

[3] Indirect factors like high temperature govern a way a user buys a shirt. The present subject matter takes many such “Indirect factors” also as valid inputs towards shirt formation.

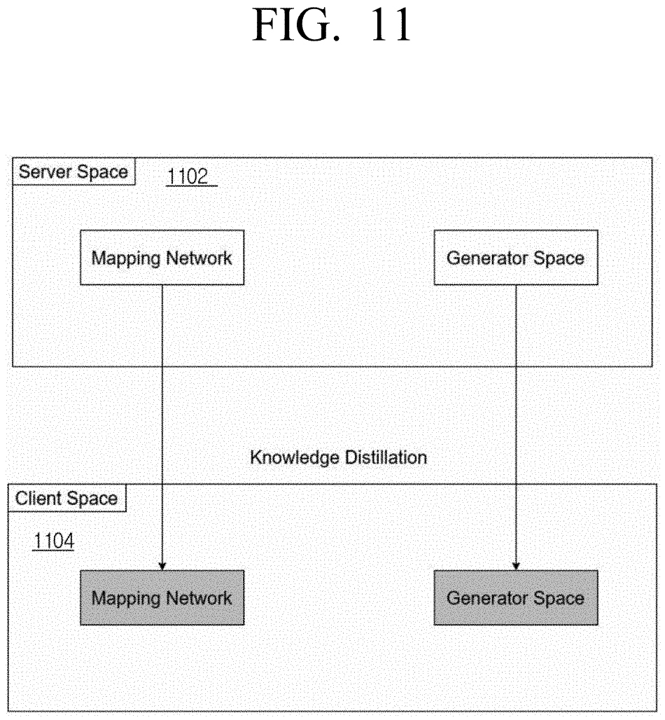

FIG. 11 illustrates an example implementation of the method steps in accordance with a client-server implementation. The present implementation refers to “Knowledge distillation” where deeper models are learned first to extract complex patterns in data. Then these complex patterns are taught to a smaller child model. This results in a much smaller memory footprint, but with similar accuracy.

In accordance with the present embodiment, the mapping network and generator network at the server 1102 leverage knowledge distillation to train smaller models on the client's 1104 device. The server 1102 implements a first version of the ANN to generate images, such that the first version of ANN is a large size model configured to undergo training and thereafter train smaller models.

The client 1104 implements a second version of the ANN configured to undergo training by the first version of the ANN as a part of knowledge distillation, wherein the client 1104 is configured to compute the optimal vector values and thereby cache the calculated values. More specifically, the client 1104 uses ‘local’ copy of generative network to compute the optimal sampling vector. The local copy as obtained is an extract from knowledge distillation and works in real-time. Multiple user-experiences on a same device are obtained. The optimal sampling vector gets stored in the local cache as user metadata.

The user metadata goes to the server 1102 as a single lazy federated update, which saves bandwidth costs. User metadata contains “numbers” instead of text/image information which ensures user privacy. This is an inherent advantage of over traditional recommendation systems that crawl through previously bought user items.

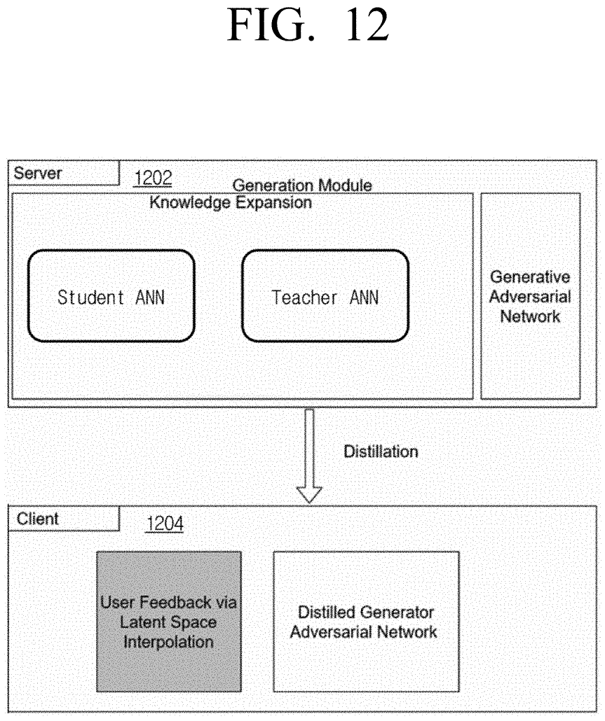

FIG. 12 illustrates an example implementation of the method steps in accordance with a client-server implementation. The implementation refers learning on unlabeled user data using knowledge expansion. Through the concepts of Knowledge Expansion and Distillation, the present implementation enables personalizing the experiences for a user even if no labelled data is given. Overall, the knowledge expansion is done before knowledge-distillation to get the same model size on client-device.

At the server end 1202, an unlabeled image in target domain is received from the user by a server 1202 implementing student and teacher ANN. The first ANN or the teacher ANN derives intermediate-labels in respect of the unlabeled image by a perceptual image-similarity criteria, wherein intermediate labels are defined by a plurality of TDA and one or more sampling vector associated with said unlabeled image. More specifically, the combination of target domain attributes and sampling vectors that generate the unlabeled image are calculated by perceptual image-similarity constraints. The representations are stored as “soft pseudo-labels” or intermediate labels for the generated sample.

An equal or larger sized second ANN is trained based on labelled data and intermediate-labelled data for image generation. A larger student network is trained on labelled data and pseudo-labelled data to learn more complex representations. Thereafter, the first ANN is substituted with the second ANN to predict intermediate-labels in respect of the unlabeled image and based thereupon retraining the second ANN. This process is iterated until the user becomes satisfied with the generated outputs. The satisfaction threshold is calculated by the relative probability of positive user responses among the total collected responses.

Upon detecting a positive user-feedback with respect image generation capacity of the second ANN, a compressed version of the trained second ANN is instantiated upon a client 1204 device based upon said detection. In other words, the ideal larger network thus obtained is again compressed to the client-device 1204 by distillation.

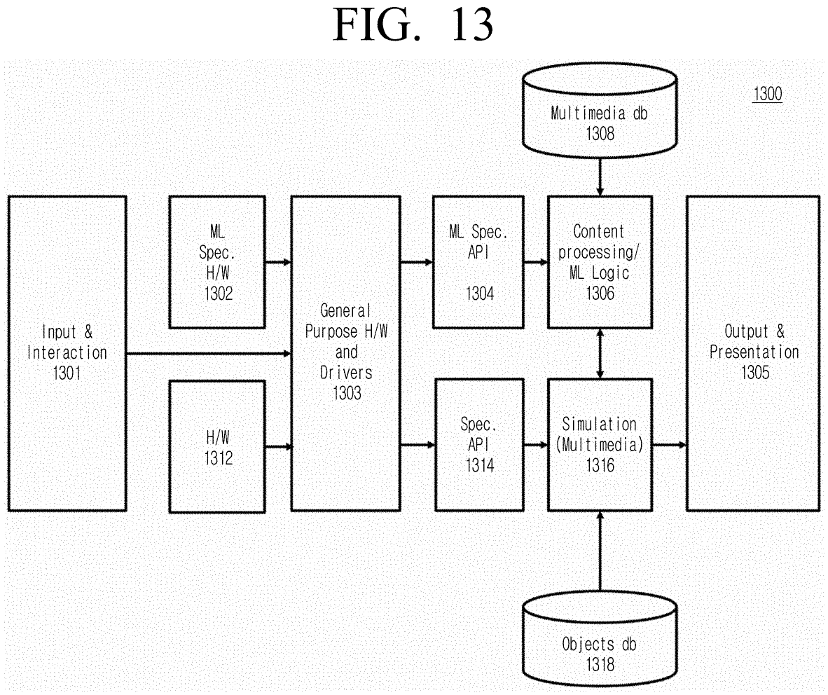

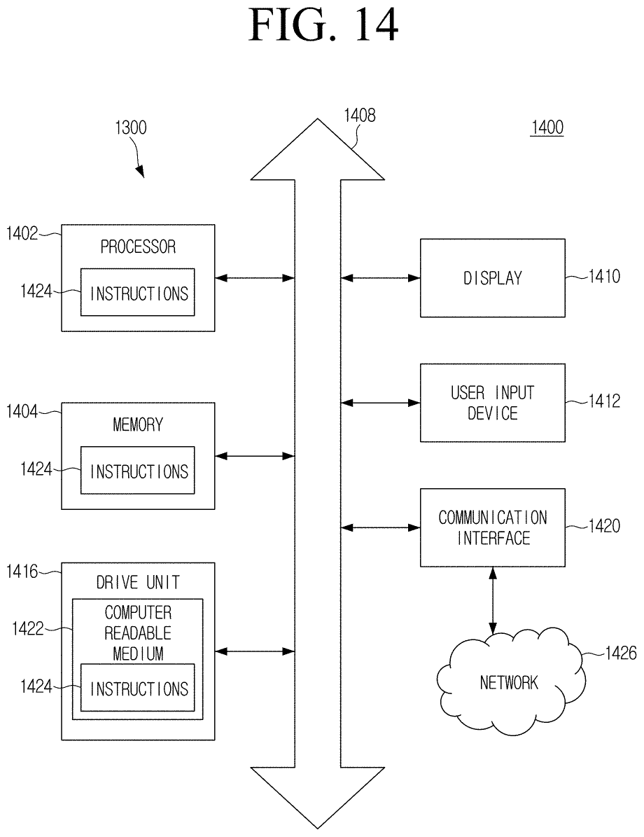

FIG. 13 illustrates a representative architecture 1300 to provide tools and development environment described herein for a technical-realization of the implementation in FIG. 1 and FIG. 12 through an AI model based computing device. FIG. 13 is merely a non-limiting example, and it will be appreciated that many other architectures may be implemented to facilitate the functionality described herein. The architecture may be executing on hardware such as a computing machine 1400 of FIG. 14 that includes, among other things, processors, memory, and various application-specific hardware components.

The architecture 1300 may include an operating-system, libraries, frameworks or middleware. The operating system may manage hardware resources and provide common services. The operating system may include, for example, a kernel, services, and drivers defining a hardware interface layer. The drivers may be responsible for controlling or interfacing with the underlying hardware. For instance, the drivers may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

A hardware interface layer includes libraries which may include system libraries such as file-system (e.g., C standard library) that may provide functions such as memory allocation functions, string manipulation functions, mathematic functions, and the like. In addition, the libraries may include API libraries such as audio-visual media libraries (e.g., multimedia data libraries to support presentation and manipulation of various media format such as MPEG4, H.264, MP3, AAC, AMR, JPG, PNG), database libraries (e.g., SQLite that may provide various relational database functions), web libraries (e.g. WebKit that may provide web browsing functionality), and the like.

A middleware may provide a higher-level common infrastructure such as various graphic user interface (GUI) functions, high-level resource management, high-level location services, and so forth. The middleware may provide a broad spectrum of other APIs that may be utilized by the applications or other software components/modules, some of which may be specific to a particular operating system or platform.

The term “module” used in this disclosure may refer to a certain unit that includes one of hardware, software and firmware or any combination thereof. The module may be interchangeably used with unit, logic, logical block, component, or circuit, for example. The module may be the minimum unit, or part thereof, which performs one or more particular functions. The module may be formed mechanically or electronically. For example, the module disclosed herein may include at least one of ASIC (Application-Specific Integrated Circuit) chip, FPGAs (Field-Programmable Gate Arrays), and programmable-logic device, which have been known or are to be developed.

Further, the architecture 1300 depicts an aggregation of computing device based mechanisms and ML/NLP based mechanism in accordance with an embodiment of the present subject matter. A user-interface defined as input and interaction 1301 refers to overall input. It can include one or more of the following—touch screen, microphone, camera etc. A first hardware module 1302 depicts specialized hardware for ML/NLP based mechanisms. In an example, the first hardware module 1302 comprises one or more of neural processors, FPGA, DSP, GPU etc.

A second hardware module 1312 depicts specialized hardware for executing the device-related audio and video simulations. ML/NLP based frameworks and APIs 1304 correspond to the hardware interface layer for executing the ML/NLP logic 1306 based on the underlying hardware. In an example, the frameworks may be one or more or the following—Tensorflow, Café, NLTK, GenSim, ARM Compute etc. Simulation frameworks and APIs 1314 may include one or more of—Device Core, Device Kit, Unity, Unreal etc.

A database 1308 depicts a pre-trained multimedia content database comprising the pre-formed clusters of multimedia content in the latent space. The database 1308 may be remotely accessible through cloud by the ML/NLP logic 1306. In other example, the database 1308 may partly reside on cloud and partly on-device based on usage statistics.

Another database 1318 refers the computing device DB that will be used to store multimedia content. The database 1318 may be remotely accessible through cloud. In other example, the database 1318 may partly reside on the cloud and partly on-device based on usage statistics.

A rendering module 1305 is provided for rendering multimedia output and trigger further utility operations as a result of user authentication. The rendering module 1305 may be manifested as a display cum touch screen, monitor, speaker, projection screen, etc.

A general-purpose hardware and driver module 1303 corresponds to the computing device 1400 as referred in FIG. 14 and instantiates drivers for the general purpose hardware units as well as the application-specific units 1302, 1312.

In an example, the NLP/ML mechanism and VPA simulations underlying the present architecture 1300 may be remotely accessible and cloud-based, thereby being remotely accessible through a network connection. A computing device such as a VPA device may be configured for remotely accessing the NLP/ML modules and simulation modules may comprise skeleton elements such as a microphone, a camera a screen/monitor, a speaker etc.

Further, at least one of the plurality of modules of FIG. 2 and FIG. 3 may be implemented through AI based on ML/NLP logic 1306. A function associated with AI may be performed through the non-volatile memory, the volatile memory, and the processor constituting the first hardware module 1302 i.e. specialized hardware for ML/NLP based mechanisms. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The aforesaid processors collectively correspond to the processor 1402 of FIG. 14.

The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that, by applying a learning logic/technique to a plurality of learning data, a predefined operating rule or AI model of a desired characteristic is made. The learning may be performed in a device (i.e. the architecture 1300 or the device 1600) itself in which AI according to an embodiment is performed, and/or may be implemented through a separate server/system.

The AI model may consist of a plurality of neural network layers. Each layer has a plurality of weight values, and performs a layer operation through calculation of a previous-layer and an operation of a plurality of weights. Examples of neural-networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The ML/NLP logic 1306 is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning.

FIG. 14 shows yet another exemplary implementation in accordance with the embodiment, and yet another typical hardware configuration of the system 1300 in the form of a computer system 1400 is shown. The computer system 1400 can include a set of instructions that can be executed to cause the computer system 1400 to perform any one or more of the methods disclosed. The computer system 1400 may operate as a standalone device or may be connected, e.g., using a network, to other computer systems or peripheral devices.

In a networked deployment, the computer system 1400 may operate in the capacity of a server or as a client user computer in a server-client user network environment, or as a peer computer system in a peer-to-peer (or distributed) network environment. The computer system 1400 can also be implemented as or incorporated across various devices, such as a VR device, personal computer (PC), a tablet PC, a personal digital assistant (PDA), a mobile device, a palmtop computer, a communications device, a web appliance, or any other machine capable of executing a set of instructions (sequential or otherwise) that specify actions to be taken by that machine. Further, while a single computer system 1400 is illustrated, the term “system” shall also be taken to include any collection of systems or sub-systems that individually or jointly execute a set, or multiple sets, of instructions to perform one or more computer functions.

The computer system 1400 may include a processor 1402 e.g., a central processing unit (CPU), a graphics processing unit (GPU), or both. The processor 1402 may be a component in a variety of systems. For example, the processor 1402 may be part of a standard personal computer or a workstation. The processor 1402 may be one or more general processors, digital signal processors, application specific integrated circuits, field programmable gate arrays, servers, networks, digital circuits, analog circuits, combinations thereof, or other now known or later developed devices for analyzing and processing data. The processor 1402 may implement a software program, such as code generated manually (i.e., programmed).

The computer system 1400 may include a memory 1404, such as a memory 1404 that can communicate via a bus 1408. The memory 1404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 1404 includes a cache or random access memory for the processor 1402. In alternative examples, the memory 1404 is separate from the processor 1402, such as a cache memory of a processor, the system memory, or other memory. The memory 1404 may be an external storage device or database for storing data. The memory 1404 is operable to store instructions executable by the processor 1402. The functions, acts or tasks illustrated in the figures or described may be performed by the programmed processor 1402 executing the instructions stored in the memory 1404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1400 may or may not further include a display unit 1410, such as a liquid crystal display (LCD), an organic light emitting diode (OLED), a flat panel display, a solid state display, a cathode ray tube (CRT), a projector, or other now known or later developed display device for outputting determined information. The display 1410 may act as an interface for the user to see the functioning of the processor 1402, or specifically as an interface with the software stored in the memory 1404 or in the drive unit 1416.

Additionally, the computer system 1400 may include an input device 1412 configured to allow a user to interact with any of the components of system 1400. The computer system 1400 may also include a disk or optical drive unit 1416. The disk drive unit 1416 may include a computer-readable medium 1422 in which one or more sets of instructions 1424, e.g. software, can be embedded. Further, the instructions 1424 may embody one or more of the methods or logic as described. In a particular example, the instructions 1424 may reside completely, or at least partially, within the memory 1404 or the processor 1402 during execution by the computer system 1400.

Embodiments include a computer-readable medium that includes instructions 1424 or receives and executes instructions 1424 responsive to a propagated signal so that a device connected to a network 1426 can communicate voice, video, audio, images or any other data over the network 1426. Further, the instructions 1424 may be transmitted or received over the network 1426 via a communication port or interface 1420 or using a bus 1408. The communication port or interface 1420 may be a part of the processor 1402 or maybe a separate component. The communication port 1420 may be created in software or maybe a physical connection in hardware. The communication port 1420 may be configured to connect with a network 1426, external media, the display 1410, or any other components in system 1400, or combinations thereof. The connection with the network 1426 may be a physical connection, such as a wired Ethernet connection or may be established wirelessly as discussed later. Likewise, the additional connections with other components of the system 1400 may be physical or may be established wirelessly. The network 1426 may alternatively be directly connected to the bus 1408.

The network 1426 may include wired networks, wireless networks, Ethernet AVB networks, or combinations thereof. The wireless network may be a cellular telephone network, an 802.11, 802.16, 802.20, 802.1Q or WiMax network. Further, the network 1426 may be a public network, such as the Internet, a private network, such as an intranet, or combinations thereof, and may utilize a variety of networking protocols now available or later developed including, but not limited to TCP/IP based networking protocols. The system is not limited to operation with any particular standards and protocols. For example, standards for Internet and other packet switched network transmission (e.g., TCP/IP, UDP/IP, HTML, HTTP) may be used.

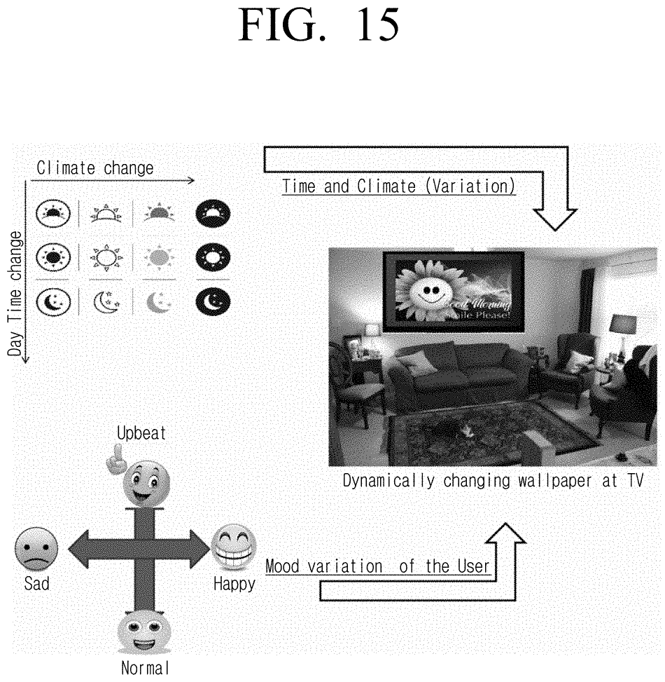

FIG. 15 illustrates an example implementation of the present subject matter and illustrates a real-time latent space-interpolation associated with external-feedback. The interpolation results in a dynamically changing wallpaper as displayed at a living-room's television.

State of the art Frame TV has the ability to camouflage its wallpaper according to the surface it is mounted on. The real-time latent space-interpolation associated with external-feedback in accordance with the present subject matter offers an additional level of personalization. Health data collected from mobile devices and wearables such as smartwatches may be used to create dynamic wallpapers on screen. In an example, during group workouts, each section of the screen can change its color according to a person's heart beat acting as the external feedback. By varying parameters in the latent-space based on external-feedback and personalization, infinite wallpapers can be formed.

In the example as depicted in present FIG. 15, the variation in time of the day coupled with climate change observed during the day provides an external feedback to dynamically generate new wallpapers through GAN. In other example, the mood swings of the living room member may be captured as upbeat, sad, happy and normal. Based on said human-emotion, the wallpaper changes dynamically.

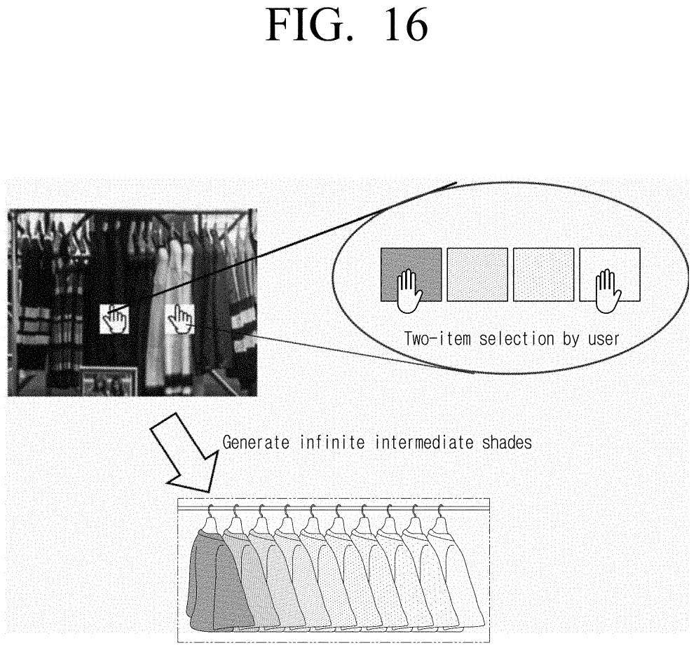

FIG. 16 illustrates an example implementation of the present subject matter and refers the ability of latent-space to interpolate based on external feedback and thereby complete an inventory of online marketplace.

As is usually observed, certain items might be out of stock during online shopping. Customers do not get an option to see the missing items. In accordance with the latent space of present subject matter, a user only needs to select two items in an inventory. The present subject matter generates infinite options in between for a user to choose from. This at least enables that sellers no longer need to spend large amounts to advertise every possible item. In an example, for a blue-colored shirt, all shades no longer need to be advertised. Furthermore, once the user has selected a particular item, new designs as generated by the latent-space interpolation can be placed as a custom order. Stakeholders can use novel generated designs to devise even more creative products.

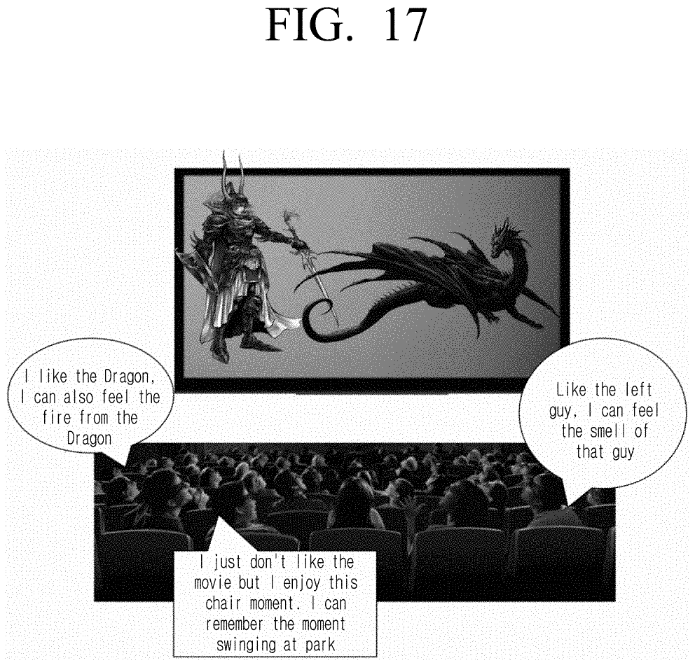

FIG. 17 illustrates an example implementation of the present subject matter and refers the ability of latent-space to interpolate and offer varied user experiences.

As may be understood, fixed points in the latent space need to be reached at a constant time. However, such points are loosely defined. In an example, while watching a movie there are some crucial moments where everyone needs same experience. These “moments” are definite points in the latent space. There are certain instances where a group of users are subjected to experiences during same time-interval. For example, different people watch a same movie for the entire duration of its length.

Now by adjusting the rate of sampling for each user in accordance with the present subject matter, varied experiences may be offered while still complying with the timing constraints. In an example, the present subject matter offers different-experiences every time a same movie gets watched. For example, in a 5D movie, the types of smells offered to the users during movie duration can be adjusted in real time.

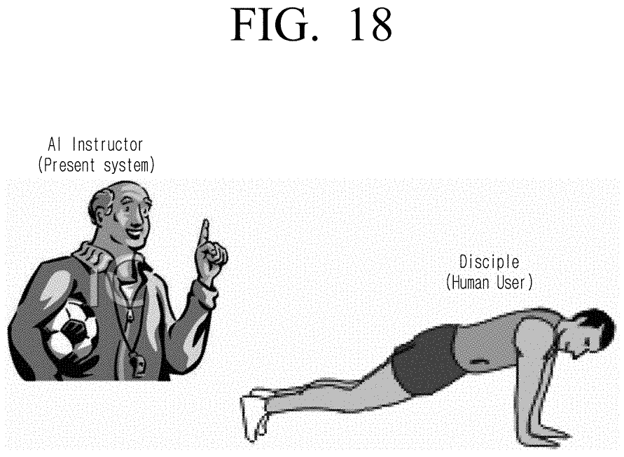

FIG. 18 illustrates an example implementation of the present subject matter and refers a Personalized Exercise Generator for rendering exercise recommendations depending on the user's physical conditions. Source domains are used to choose a dynamic final point in the latent space of the target domain. Based thereupon, the trajectory of interpolation gets adjusted accordingly.

State of the art fitness-regime systems are able to recommend exercises and auto-correct posture of a person in real time. However, the drawn prediction is usually very broad. The user is asked to specify what kind of goal he wants to achieve. In an example, the goal may be 100 push-ups in a day. By assuming the goal to be constant, the user performance is evaluated and recommendations are given.

In our system, user parameters (like health) are used to change the goal in real time. In an example, if a person is feeling-sick, his heart beat may be too high. Instead of expecting him to complete 100 push-ups that he selected, the present subject matter expects him to do 70. So the fitness regimen gets auto-corrected in real time.

Overall, the present subject matter offers significant advantages over the state of the art. As user personalization is crucial for the success any service industry, the present subject matter leverages AI models such as Generative Adversarial Networks (GAN) to deliver infinite experiences to users using fixed memory and compute and thereby mends a long standing gap between machines and humans.

As may be understood, Neural networks learn complex patterns, but don't know which ones are relevant to a human. On the other hand, while humans can “look” at a pattern and select which ones they like, however they cannot generate new things as quickly in their minds. The present subject matter renders a human-computer interface (HCI) and bridges such gap by using a machine to generate variety, and asking a human whether he likes it or not. The present subject matter at least enables a machine to learn based on human-specific biases to generate patterns relevant for a human.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A device comprising:
a memory configured to store a neural network model; and
a processor configured to:
receive a first user input,
identify a first identified domain corresponding to the first user input among a plurality of predefined domains,
distinguish, based on first information related to at least one domain attribute among a plurality of predefined domain attributes being included in the first user input, attributes of a plurality of images corresponding to the first identified domain,
obtain at least one image included in the first identified domain and corresponding to the at least one domain attribute through the neural network model, and
provide the at least one image as an output.

2. The device of claim 1, wherein the first information comprises at least one of: i) direct information for selecting the at least one domain attribute, or ii) first indirect information relating to the at least one domain attribute, and
wherein the processor, based on the first indirect information being included in the first user input, is further configured to:
map the first indirect information to a first domain attribute predefined as corresponding to the first indirect information,
identify the at least one domain attribute including a second domain attribute corresponding to the direct information and the first domain attribute, and
obtain the at least one image corresponding to the at least one domain attribute.

3. The device of claim 2, wherein the processor, based on the at least one image being obtained, is further configured to:
obtain second indirect information relating to the at least one domain attribute from the at least one image,
based on the second indirect information being matched with the first indirect information, provide the at least one image, and
based on the second indirect information being not matched with the first indirect information, retrain the neural network model.

4. The device of claim 1, wherein the processor, based on a second user input including feedback information on the at least one image being received, is configured to:
adjust the at least one domain attribute based on the feedback information, and
obtain the at least one image corresponding to at least one adjusted domain attribute.

5. The device of claim 4, wherein the feedback information is configured to include positive feedback information on a first image among the at least one image, and negative feedback information on a second image among the at least one image, and
wherein the at least one adjusted domain attribute is configured to include one or more domain attributes excluding a first plurality of domain attributes corresponding to the second image among a second plurality of domain attributes corresponding to the first image.

6. A method comprising:
receiving an external input for image-generation by an artificial neural network (ANN), the ANN configured to operate in respect of a first plurality of target domain attributes (TDA) for a target domain;
shortlisting a second plurality of TDA from the first plurality of TDA based on the external input and one or more clusters associated with the first plurality of TDA;
interpolating data within a latent space, wherein the latent space is based on the second plurality of TDA, wherein the interpolating comprises determining a direction of interpolation based on:
(i) a sampling vector, wherein the sampling vector is determined based on at least one of: (a) the external-input or (b) said one or more clusters; and/or
(ii) an automatically-learned relation within a first plurality of latent codes in the latent space for predicting latent codes;
generating a second latent code based on the interpolating along the direction; and
creating at least one image by the ANN based on the second latent code.

7. The method of claim 6, wherein the direction of interpolation is determined based on:
aggregating logged sampling vectors with a current computed sampling vector to obtain an aggregated vector through weighted averaging;
computing a pattern of variation among the first plurality of latent codes based on the relation within the latent space through a neural network; and
deriving an aggregated direction based on directions associated with the aggregated vector and the computed pattern to obtain a federated update to the direction of interpolation.

8. The method of claim 7, wherein the sampling vector is based on:
deriving a first vector as a user sampling vector (USV) from the external input;
deriving a second vector as a cluster sampling vector (CSV) from clusters related to the second plurality of TDA; and
combining the first vector and the second vector to obtain the sampling vector.

9. The method of claim 6, wherein the receiving the external input comprises:
receiving one or more user labels electronically or acoustically, said the one or more user labels optionally accompanied with one or more source domain attributes;
mapping the user labels with one or more target domain attributes to facilitate the shortlisting; and
mapping one or more accompanying source domain attributes with the second plurality of TDA.

10. The method of claim 6, wherein receiving the external input comprises receiving the external input as an automatically-generated trigger based on steps comprising:
predicting intermediate labels within the latent space based on the first plurality of latent codes; and
disentangling the first plurality of TDA based on the intermediate labels until attainment of a threshold defined by a user feedback; and
obtaining the second plurality of TDA based on the disentangled first plurality of TDA.

11. The method of claim 6, wherein the ANN is based on a plurality of characteristics including one or more of:
a) disentangled TDA representations for rendering a starting point in the latent space for image generation; or
b) a plurality of initialized vectors defined by one or more of: i) the cluster sampling vector CSV or ii) a cluster preference vector (CPV).

12. The method of claim 6, wherein the shortlisting of the TDA further comprises:
identifying one or more clusters within the latent space associated with the second plurality of TDA and identifying one or more cluster preference vectors (CPV) based on the second latent space;
computing a user-preference vector (UPV) based on the received external input comprising a user label and optionally including source domain information;
ranking the second plurality of TDA relevant to the external input by combining the cluster preference vector (CPV) and the UPV; and
defining the ranked and shortlisted TDA and one or more combinations thereof for initiating the interpolation within the latent space.

13. The method of claim 9, wherein the interpolation within the latent space based on the sampling vector comprises:
computing a user sampling vector (USV) from the external input and a mapping drawn between the source domain attribute and the target domain attribute;
combining the USV, and a sampling vector of the identified cluster to provide a resultant sampling vector;
determining a magnitude and direction associated with the resultant sampling vector; and
generating a second plurality of latent codes in the latent space by interpolating along the direction of resultant sampling vector based on the determined magnitude.

14. The method of claim 12, further comprising: updating one or more clusters based on the resultant sampling vector, the one or more clusters defined by:
a) a cluster comprising the second plurality of TDA; and
b) one or more clusters linked to at least one TDA out of the second plurality of TDA.

15. The method of claim 6, wherein the interpolation of the latent space based on the external input comprises:
resolving the resultant sampling vector into a unit directional vector and a corresponding magnitude; and
generating multiple latent codes along the unit directional vector by maintaining constant magnitude.

16. The method of claim 6, wherein the interpolation of the latent space based on the automatically-learned relation within the latent space comprises:
searching, through a subspace defined by the second plurality of TDA, one or more latent codes configured to generate images in the target domain; and
training a neural network to compute a relation among the latent codes within the subspace to thereby enable prediction of additional latent codes based on the computed relation.

17. The method of claim 7, wherein the receiving of the external input further comprises:
receiving multiple user feedback pertaining to the images generated as a part of the latent space interpolation;
within the interpolated latent space, calculating optimal vector values for the user for a particular combination of the target domain attributes as one or more of:
an optimal user sampling vector (USV) based on an average distance associated with respect to positive feedback; or
an optimal user preference vector (UPV) obtained based on a relation between positive feedback and negative feedback.

18. The method of claim 17, further comprising reconstructing a plurality of source domain attributes based on the target domain attributes, wherein the reconstructing comprises:
aggregating the calculated optimal vector values specific to the user and the second plurality of TDA to provide an aggregated feature vector;
reconstructing information for each of the plurality of source domains based on the aggregated feature vector through a decoder forming a part of a common network;
comparing the reconstructed information with the source domain information received within the user input to compute the efficiency of the second plurality of TDA; and
updating the second plurality of TDA to augment the efficiency and updating, based on the efficiency, one or more of the USV, UPV, CSV, CPV and at least one cluster associated with the second plurality of TDA.

19. The method as claimed in claim 18, further comprising:
receiving another user feedback for augmenting the efficiency; and
based on the another received feedback, updating the second plurality of TDA for further reconstructing the source domain attributes;
based upon the further reconstructed source domain attributes, achieving one or more of:
further optimized sampling vector for the user for the second plurality of TDA,
updated cluster sampling vector & the cluster preference vector, or
updating of at least one cluster related to one or more of the second plurality of TDA.

20. A non-transitory computer readable medium storing instructions, the instructions configured to cause a computer to perform steps including:
receiving a first user input;
identifying a first identified domain corresponding to the first user input among a plurality of predefined domains;
distinguishing, based on first information related to at least one domain attribute among a plurality of predefined domain attributes being included in the first user input, attributes of a plurality of images corresponding to the first identified domain;
obtaining at least one image included in the first identified domain and corresponding to the at least one domain attribute through the neural network model; and
providing the at least one image as an output.
